(19) United States
(12) Patent Application Publication
(10) Pub. No.: US 2024/0176459 A1
(43) Pub. Date: May 30, 2024

(54) WEARABLE TERMINAL DEVICE, PROGRAM, AND DISPLAY METHOD

(71) Applicant: KYOCERA Corporation, Kyoto (JP)

(72) Inventors: Shingo ITO, Kyoto-shi, Kyoto (JP); Tomokazu ADACHI, Yokohama-shi, Kanagawa (JP); Kai SHIMIZU, Yokohama-shi, Kanagawa (JP)

(73) Assignee: KYOCERA Corporation, Kyoto (JP)

(21) Appl. No.: 18/551,858

(22) PCT Filed: Mar. 29, 2021
(86) PCT No.: PCT/JP2021/013299

§ 371 Date: Sep. 21, 2023

(51) Int. Cl. G06F 3/04815; G06F 3/0482; G06F 3/04845; G06F 3/0485; G06F 3/0486

(52) U.S. Cl. CPC G06F 3/04815; G06F 3/0482; G06F 3/04845; G06F 3/0485; G06F 3/0486

(57) ABSTRACT

A wearable terminal device that is configured to be used by being worn by a user includes at least one processor. The at least one processor detects a visible area for the user in a space. The at least one processor causes a display to display, out of virtual images located in the space, a first virtual image that is located inside the visible area. When a second virtual image located outside the visible area is present, the at least one processor causes the display to perform display indicating in a prescribed manner existence of the second virtual image.

### TECHNICAL FIELD

The present disclosure relates to a wearable terminal device, a program, and a display method.

### BACKGROUND OF INVENTION

Heretofore, virtual reality (VR), mixed reality (MR), and augmented reality (AR) are known technologies that allow a user to experience virtual images and/or virtual spaces by using a wearable terminal device that is worn on the head of the user. A wearable terminal device includes a display that covers the field of view of the user when worn by the user. Virtual images and/or virtual spaces are displayed on this display in accordance with the position and orientation of the user in order to achieve a visual effect in which the virtual images and/or virtual spaces appear to actually exist (for example, specification of U.S. Patent Application Publication No. 2019/0087021 and specification of U.S. Patent Application Publication No. 2019/0340822).

MR is a technology that allows users to experience a mixed reality in which a real space and virtual images are merged together by displaying virtual images that appear to exist at prescribed positions in the real space while the user sees the real space. VR is a technology that allows a user to feel as though he or she is in a virtual space by allowing him or her to see a virtual space instead of a real space in MR.

Virtual images displayed in VR and MR have display positions defined in the space in which the user is located, and the virtual images are displayed on the display and are visible to the user when the display positions are within a visible area for the user.

### SUMMARY

A wearable terminal device of the present disclosure is configured to be used by being worn by a user. The wearable terminal device includes at least one processor. The at least one processor is configured to detect a visible area for the user in a space. The at least one processor causes a display to display, out of virtual images located in the space, a first virtual image that is located inside the visible area. When a second virtual image located outside the visible area is present, the at least one processor causes the display to perform display indicating in a prescribed manner existence of the second virtual image.

A program of the present disclosure is configured to cause a computer to execute detecting a visible area for a user inside a space, the computer being provided in a wearable terminal device configured to be used by being worn by the user. The program causes the computer to execute causing a display to display, out of virtual images located in the space, a first virtual image that is located inside the visible area. When a second virtual image located outside the visible area is present, the program causes the computer to execute causing the display to perform display indicating in a prescribed manner existence of the second virtual image.

A display method of the present disclosure is a display method for use in a wearable terminal device configured to be used by being worn by a user. The display method includes detecting a visible area for the user in a space. The display method includes causing a display to display, out of virtual images located in the space, a first virtual image that is located inside the visible area. The display method includes, when a second virtual image located outside the visible area is present, causing the display to perform display indicating in a prescribed manner existence of the second virtual image.

### BRIEF DESCRIPTION OF THE DRAWINGS

FIG. 1 is a schematic perspective view illustrating the configuration of a wearable terminal device according to a First Embodiment.

FIG. 2 illustrates an example of a visible area and a virtual image seen by a user wearing a wearable terminal device.

FIG. 3 is a diagram for explaining a visible area in space.

FIG. 4 is a block diagram illustrating the main functional configuration of the wearable terminal device.

FIG. 5 is a flowchart illustrating the control procedure of virtual image display processing.

FIG. 6 illustrates a list screen for allowing the existence of a second virtual image to be recognized and an indicator displayed in response to an operation performed on the list screen.

FIG. 7 is a diagram illustrating a change in display mode in response to an operation performed on the list screen.

FIG. 8 is a diagram illustrating an operation of copying a virtual image in response to an operation performed on the list screen.

FIG. 9 is a diagram illustrating an operation of moving a virtual image in response to an operation performed on the list screen.

FIG. 10 is a diagram illustrating an operation of deleting a virtual image in response to an operation performed on the list screen.

FIG. 11 is a diagram illustrating another example of a list screen.

FIG. 12 is a diagram illustrating a display operation for making a user aware of the existence of a second virtual image using an indicator.

FIG. 13 is a flowchart illustrating the control procedure of virtual image display processing.

FIG. 14 is a diagram illustrating an operation of moving second virtual images into a visible area in order to make the user aware of the presence of the second virtual images.

FIG. 15 is a diagram illustrating an example of aligning virtual images with the front surfaces of the images facing the user.

FIG. 16 is a diagram illustrating an example of aligning virtual images with the rear surfaces of the images facing the user.

FIG. 17 is a diagram illustrating an example of aligning first virtual images and second virtual image according to different rules.

FIG. 18 is a diagram illustrating an example of displaying a scrolling screen.

FIG. 19 is a diagram illustrating an example in which second virtual images are superimposed on first virtual images.

FIG. 20 is a diagram illustrating an example in which second virtual images are displayed in a prescribed emphasized manner.

FIG. 21 is a diagram illustrating an example in which first virtual images are displayed in a prescribed suppressed manner.

FIG. 22 is a diagram illustrating a display operation of moving virtual images so that first virtual images and second virtual images do not overlap.

FIG. 23 is a diagram illustrating a display operation of returning a second virtual image to its original position.

FIG. 24 is a diagram illustrating a line tied to a second virtual image that has been returned to its original position.

FIG. 25 is a diagram illustrating an example of a list image when there are multiple spaces.

FIG. 26 is a diagram illustrating an operation of moving second virtual images into a visible area when there are multiple spaces.

FIG. 27 is a schematic diagram illustrating the configuration of a display system according to a Second Embodiment.

FIG. 28 is a block diagram illustrating the main functional configuration of an information processing apparatus.

### DESCRIPTION OF EMBODIMENTS

Hereafter, embodiments will be described based on the drawings. However, for convenience of explanation, each figure referred to below is a simplified illustration of only the main components that are needed in order to describe the embodiments. Therefore, a wearable terminal device 10 and an information processing apparatus 20 of the present disclosure may include any components not illustrated in the referenced figures.

### First Embodiment

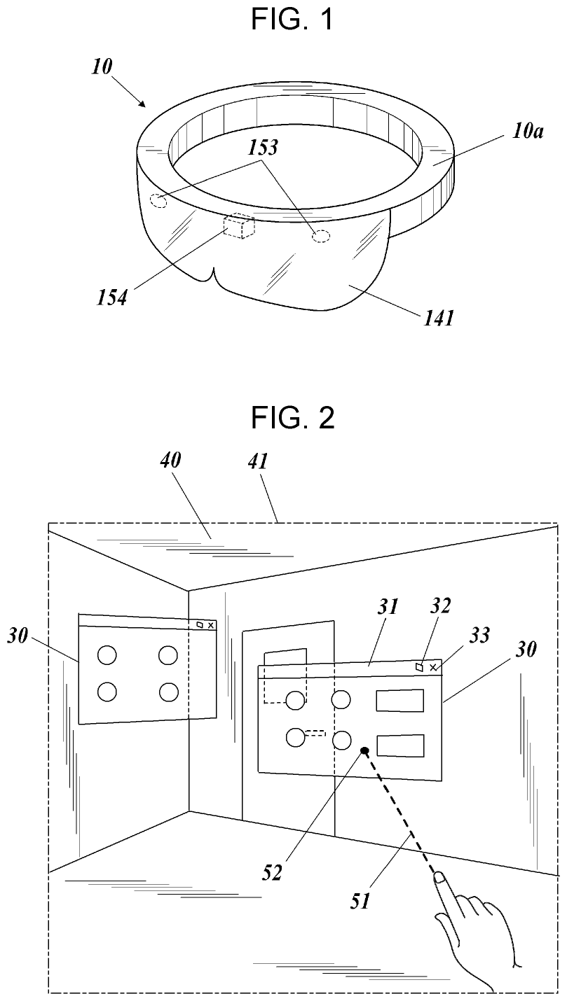

As illustrated in FIG. 1, the wearable terminal device 10 includes a body 10a and a visor 141 (display member) attached to the body 10a.

The body 10a is a ring-shaped member whose circumference can be adjusted. Various devices, such as a depth sensor 153 and a camera 154, are built into the body 10a. When the body 10a is worn on the user's head, the user's field of view is covered by the visor 141.

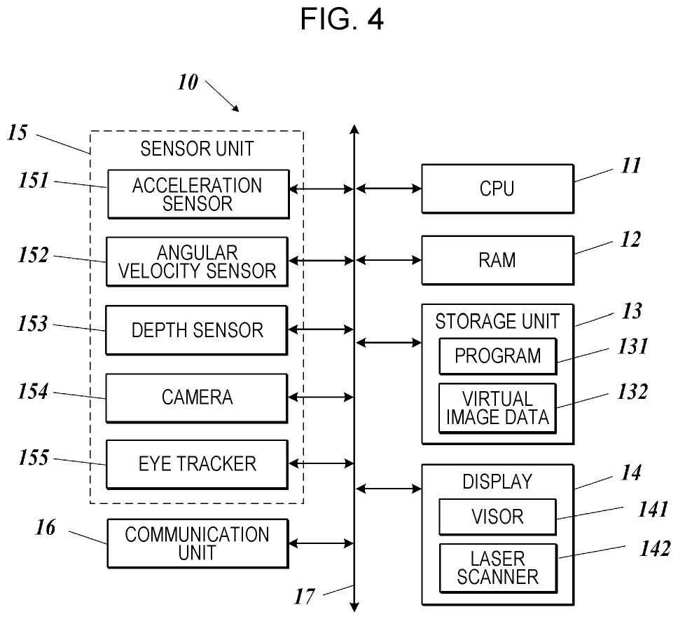

The visor 141 is transparent to light. The user can see a real space through the visor 141. An image such as a virtual image is projected and displayed on a display surface of the visor 141, which faces the user's eyes, from a laser scanner 142 (refer to FIG. 4), which is built into the body 10a. The user sees the virtual image in the form of light reflected from the display surface. At this time, since the user is also viewing the real space through the visor 141, a visual effect is obtained as though the virtual image exists in the real space.

As illustrated in FIG. 2, with virtual images 30 displayed, the user sees the virtual images 30 at prescribed positions in a space 40 with the virtual images 30 facing in prescribed directions. In this embodiment, the space 40 is the real space that the user sees through the visor 141. The virtual images 30 are projected onto a light-transmissive visor 141 so as to be seen as translucent images superimposed on the real space. In FIG. 2, an example is illustrated in which the virtual images 30 are flat window screens, but the virtual images 30 are not limited to being flat window screens, and may be objects such as arrows or various three-dimensional images. If the virtual images 30 are window screens, the virtual images 30 have front surfaces (first surfaces) and rear surfaces (second surfaces), and necessary information is displayed on the front surfaces and typically no information is displayed on the rear surfaces.

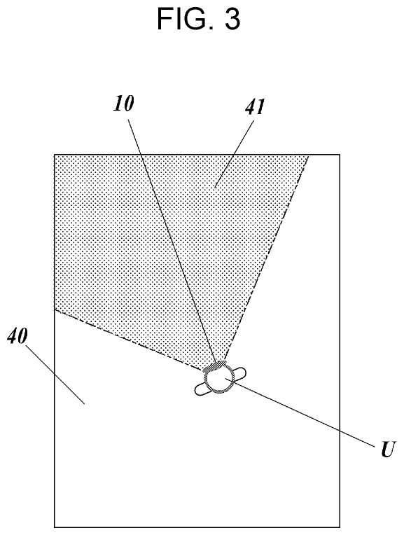

The wearable terminal device 10 detects a visible area 41 for the user based on the position and orientation of the user in the space 40 (in other words, the position and orientation of the wearable terminal device 10). As illustrated in FIG. 3, the visible area 41 is the area of the space 40 that is located in front of a user U wearing the wearable terminal device 10. For example, the visible area 41 is an area within a prescribed angular range from the front of user U in the left-right directions and up-down directions. In this case, a cross section obtained when a three-dimensional object corresponding to the shape of the visible area 41 is cut along a plane perpendicular to the frontal direction of the user U is rectangular. The shape of the visible area 41 may be defined so that the cross section has a shape other than a rectangular shape (for example, a circular or oval shape). The shape of the visible area 41 (for example, the angular range from the front in left-right directions and up-down directions) can be specified for example using the following method.

In the wearable terminal device 10, the field of view is adjusted (hereinafter referred to as “calibrated”) in a prescribed procedure at a prescribed timing, such as when the device is first started up. In this calibration, the area that can be seen by the user identified, and the virtual images 30 are displayed within that area thereafter. The shape of the visible area 41 can be set as the shape of the visible area identified by this calibration.

Calibration is not limited to being performed using the prescribed procedure described above, and calibration may be performed automatically during normal operation of the wearable terminal device 10. For example, if the user does not react to a display that the user is supposed to react to, the field of view (and the shape of the visible area 41) may be adjusted while assuming that the area where the display is performed is outside the user's field of view. The field of view (and the shape of the visible area 41) may be adjusted by performing display on a trial basis at a position that is defined as being outside the range of the field of view, and if the user does react to the display, the area where the display is performed may be considered as being within the range of the user's field of view.

The shape of the visible area 41 may be determined in advance and fixed at the time of shipment or the like and not based on the result of adjustment of the field of view. For example, the shape of the visible area 41 may be defined by the optical design of a display 14 to the maximum extent possible.

The virtual images 30 are generated in accordance with prescribed operations performed by the user with display positions and orientations defined in the space 40. Out of the generated virtual images 30, the wearable terminal device 10 displays the virtual images 30 whose display positions are defined inside the visible area 41 by projecting the virtual images 30 onto the visor 141. In FIG. 2, the visible area 41 is represented by a chain line.

The display positions and orientations of the virtual images 30 on the visor 141 are updated in real time in accordance with changes in the visible area 41 for the user. In other words, the display positions and orientations of the virtual images 30 change in accordance with changes in the visible area 41 so that the user perceives that “the virtual images 30 are located within the space 40 at set positions and with set orientations”. For example, as the user moves from the front sides to the rear sides of the virtual images 30, the shapes (angles) of the displayed virtual images 30 gradually change in accordance with this movement. When the user moves around to the rear side of a virtual image 30 and then turns toward the virtual image 30, the rear surface of the virtual image 30 is displayed so that the user can see the rear surface. In accordance with changes in the visible area 41, the virtual images 30 whose display positions have shifted out of the visible area 41 are no longer displayed, and if there are any virtual images 30 whose display positions have now entered the visible area 41, those virtual images 30 are newly displayed.

As illustrated in FIG. 2, when the user holds his or her hand (or finger) forward, the direction in which the hand is extended is detected by the wearable terminal device 10, and a virtual line 51 extending in that direction and a pointer 52 are displayed on the display surface of the visor 141 for the user to see. The pointer 52 is displayed at the intersection of the virtual line 51 and a virtual image 30. If the virtual line 51 does not intersect any virtual image 30, the pointer 52 may be displayed at the intersection of the virtual line 51 and a wall of the space 40 or the like. When the distance between the hand of the user and the virtual image 30 is within a prescribed reference distance, the pointer 52 may be directly displayed at a position corresponding to the finger tip of the user without displaying the virtual line 51.

The user can adjust the direction of the virtual line 51 and the position of the pointer 52 by changing the direction in which the user extends his or her hand. When a prescribed gesture is performed with the pointer 52 adjusted so as to be positioned at a prescribed operation target (for example, a function bar 31, a window shape change button 32, or a close button 33) included in the virtual image 30, the gesture can be detected by the wearable terminal device 10 and a prescribed operation can be performed on the operation target. For example, with the pointer 52 aligned with the close button 33, the virtual image 30 can be closed (deleted) by performing a gesture for selecting an operation target (for example, a pinching gesture made using the fingertips). The virtual image 30 can be moved in the depth direction and in left-right directions by making a selection gesture with the pointer 52 aligned with the function bar 31, and then making a gesture of moving the hand back and forth and left and right while maintaining the selection gesture. Operations that can be performed on the virtual images 30 are not limited to these examples.

Thus, the wearable terminal device 10 of this embodiment can realize a visual effect as though the virtual images 30 exist in the real space, and can accept user operations performed on the virtual images 30 and reflect these operations in the display of the virtual images 30. In other words, the wearable terminal device 10 of this embodiment provides MR.

Next, the functional configuration of the wearable terminal device 10 will be described while referring to FIG. 4.

The wearable terminal device 10 includes a central processing unit (CPU) 11, a random access memory (RAM) 12, a storage unit 13, the display 14, a sensor unit 15, and a communication unit 16, and these components are connected to each other by a bus 17. Each of the components illustrated in FIG. 4, except for the visor 141 of the display 14, is built into the body 10a and operates with power supplied from a battery, which is also built into the body 10a.

The CPU 11 is a processor that performs various arithmetic operations and performs overall control of the operations of the various parts of the wearable terminal device 10. The CPU 11 reads out and executes a program 131 stored in storage unit 13 in order to perform various control operations. The CPU 11 executes the program 131 in order to perform, for example, visible area detection processing and display control processing. Among these processing operations, the visible area detection processing is processing for detecting the visible area 41 for the user inside the space 40. The display control processing is processing for causing the display 14 to display the virtual images 30 whose positions are defined inside the visible area 41 from among the virtual images 30 whose positions are defined in the space 40.

A single CPU 11 is illustrated in FIG. 4, but the configuration is not limited to a single CPU 11. Two or more processors, such as CPUs, may be provided, and these two or more processors may share the processing performed by the CPU 11 in this embodiment.

The RAM 12 provides a working memory space for the CPU 11 and stores temporary data.

The storage unit 13 is a non-transitory recording medium that can be read by the CPU 11 serving as a computer. The storage unit 13 stores the program 131 executed by the CPU 11 and various settings data. The program 131 is stored in storage unit 13 in the form of computer-readable program code. For example, a nonvolatile storage device such as a solid state drive (SSD) including a flash memory can be used as the storage unit 13.

The data stored in storage unit 13 includes virtual image data 132 relating to virtual images 30. The virtual image data 132 includes data relating to display content of the virtual images 30 (for example, image data), display position data, and orientation data.

The display 14 includes the visor 141, the laser scanner 142, and an optical system that directs light output from the laser scanner 142 to the display surface of the visor 141. The laser scanner 142 irradiates the optical system with a pulsed laser beam, which is controlled so as to be switched on and off for each pixel, while scanning the beam in prescribed directions in accordance with a control signal from the CPU 11. The laser light incident on the optical system forms a display screen composed of a two-dimensional pixel matrix on the display surface of the visor 141. The method employed by the laser scanner 142 is not particularly limited, but for example, a method in which the laser light is scanned by operating a mirror using micro electro mechanical systems (MEMS) can be used. The laser scanner 142 includes three light-emitting units that emit laser light in colors of RGB, for example. The display 14 can perform color display by projecting light from these light-emitting units onto the visor 141.

The sensor unit 15 includes an acceleration sensor 151, an angular velocity sensor 152, the depth sensor 153, the camera 154, and an eye tracker 155. The sensor unit 15 may further include sensors that are not illustrated in FIG. 4.

The acceleration sensor 151 detects the acceleration and outputs the detection results to the CPU 11. From the detection results produced by the acceleration sensor 151, translational motion of the wearable terminal device 10 in directions along three orthogonal axes can be detected.

The angular velocity sensor 152 (gyro sensor) detects the angular velocity and outputs the detection results to the CPU 11. The detection results produced by the angular velocity sensor 152 can be used to detect rotational motion of the wearable terminal device 10.

The depth sensor 153 is an infrared camera that detects the distance to a subject using the time of flight (ToF) method, and outputs the distance detection results to the CPU 11. The depth sensor 153 is provided on a front surface of the body 10a such that images of the visible area 41 can be captured. The entire space 40 can be three-dimensionally mapped (i.e., a three-dimensional structure can be acquired) by repeatedly performing measurements using the depth sensor 153 each time the position and orientation of the user change in the space 40 and then combining the results.

The camera 154 captures images of the space 40 using a group of RGB imaging elements, acquires color image data as results of the image capturing, and outputs the results to the CPU 11. The camera 154 is provided on the front surface of the body 10a so that images of the visible area 41 can be captured. The images output from the camera 154 are used to detect the position, orientation, and so on of the wearable terminal device 10, and are also transmitted from the communication unit 16 to an external device and used to display the visible area 41 for the user of the wearable terminal device 10 on the external device.

The eye tracker 155 detects the user's line of sight and outputs the detection results to the CPU 11. The method used for detecting the line of sight is not particularly limited, but for example, a method can be used in which an eye tracking camera is used to capture images of the reflection points of near-infrared light in the user's eyes, and the results of that image capturing and the images captured by the camera 154 are analyzed in order to identify a target being looked at by the user. Part of the configuration of the eye tracker 155 may be provided in or on a peripheral portion of the visor 141, for example.

The communication unit 16 is a communication module that includes an antenna, a modulation-demodulation circuit, and a signal processing circuit. The communication unit 16 transmits and receives data via wireless communication with external devices in accordance with a prescribed communication protocol.

In the wearable terminal device 10 having the above-described configuration, the CPU 11 performs the following control operations.

The CPU 11 performs three-dimensional mapping of the space 40 based on distance data to a subject input from the depth sensor 153. The CPU 11 repeats this three-dimensional mapping whenever the position and orientation of the user change, and updates the results each time. The CPU 11 also performs three-dimensional mapping for each connected space 40 serving as a unit. Therefore, when the user moves between multiple rooms that are partitioned from each other by walls and so on, the CPU 11 recognizes each room as a single space 40 and separately performs three-dimensional mapping for each room.

The CPU 11 detects the visible area 41 for the user in the space 40. In detail, the CPU 11 identifies the position and orientation of the user (wearable terminal device 10) in the space 40 based on detection results from the acceleration sensor 151, the angular velocity sensor 152, the depth sensor 153, the camera 154, and the eye tracker 155, and accumulated three-dimensional mapping results. The visible area 41 is then detected (identified) based on the identified position and orientation and the predetermined shape of the visible area 41. The CPU 11 continuously detects the position and orientation of the user in real time, and updates the visible area 41 in conjunction with changes in the position and orientation of the user. The visible area 41 may be detected using detection results from some of the components out of the acceleration sensor 151, the angular velocity sensor 152, the depth sensor 153, the camera 154, and the eye tracker 155.

The CPU 11 generates the virtual image data 132 relating to the virtual images 30 in accordance with operations performed by the user. In other words, upon detecting a prescribed operation (gesture) instructing generation of a virtual image 30, the CPU 11 identifies the display content (for example, image data), display position, and orientation of the virtual image, and generates virtual image data 132 including data representing these specific results.

The CPU 11 causes the display 14 to display virtual images 30 whose display positions are defined inside the visible area 41. Hereinafter, virtual images 30 whose display positions are defined inside the visible area 41, i.e., virtual images 30 located inside the visible area 41, are also referred to as “first virtual images 30A”. In addition, virtual images 30 whose display positions are defined outside the visible area 41, i.e., virtual images 30 located outside the visible area 41, are also referred to as “second virtual images 30B”. Here, the meaning of “outside the visible area 41” is assumed to include a separate space 40 that is separate from the space 40 in which the user is located. The CPU 11 identifies first virtual images 30A based on the information of the display positions included in the virtual image data 132, and generates image data of the display screen to be displayed on the display 14 based on the positional relationship between the visible area 41 and the display positions of the first virtual images 30A at that point in time. The CPU 11 causes the laser scanner 142 to perform a scanning operation based on this image data in order to form a display screen containing the first virtual images 30A on the display surface of the visor 141. In other words, the CPU 11 causes the first virtual images 30A to be displayed on the display surface of the visor 141 so that the first virtual images 30A are visible in the space 40 seen through the visor 141. By continuously performing this display control processing, the CPU 11 updates the display contents displayed on the display 14 in real time so as to match the user's movements (changes in the visible area 41). If the wearable terminal device 10 is set up to continue holding the virtual image data 132 even after the wearable terminal device 10 is turned off, the next time the wearable terminal device 10 is turned on, the existing virtual image data 132 is read and if there are first virtual images 30A located inside the visible area 41, these first virtual images 30A are displayed on the display 14.

The virtual image data 132 may be generated based on instruction data acquiring from an external device via the communication unit 16, and virtual images 30 may be displayed based on this virtual image data 132. Alternatively, the virtual image data 132 itself may be acquired from an external device via the communication unit 16 and virtual images 30 may be displayed based on the virtual image data 132. For example, an image captured by the camera 154 of the wearable terminal device 10 may be displayed on an external device operated by a remote instructor, an instruction to display the virtual image 30 may be accepted from the external device, and the instructed virtual image 30 may be displayed on the display 14 of the wearable terminal device 10. This makes it possible, for example, for a remote instructor to instruct a user of the wearable terminal device 10 in how to perform a task by displaying a virtual image 30 illustrating the work to be performed in the vicinity of a work object.

The CPU 11 detects the position and orientation of the user's hand (and/or fingers) based on images captured by the depth sensor 153 and the camera 154, and causes the display 14 to display a virtual line 51 extending in the detected direction and the pointer 52. The CPU 11 detects a gesture made by the user's hand (and/or fingers) based on images captured by the depth sensor 153 and the camera 154, and performs processing in accordance with the content of the detected gesture and the position of the pointer 52 at that time.

Next, the operation of the wearable terminal device 10 when there are second virtual images 30B outside the visible area 41 will be described.

As described above, in the wearable terminal device 10, the first virtual images 30A, whose display positions are defined inside the visible area 41, are displayed on the display and are visible to the user. Therefore, heretofore, there has been an issue in that the user has been unable to check whether or not there are second virtual images 30B outside the visible area 41 while at that position. Once a virtual image 30 has been created, the virtual image 30 remains in the space 40 until deleted. Therefore, if the user moves around while virtual images 30 are being generated, the user may have difficulty in keep track of the positions of the virtual images 30, and the issue described above is a problem. In particular, when the wearable terminal device 10 is set up to not erase the virtual images 30 (virtual image data 132) even when the wearable terminal device 10 is turned off, the user would be inconvenienced if an existing second virtual image 30B outside the visible area 41 could not be recognized when the wearable terminal device 10 is turned on again.

Therefore, when there is a second virtual image 30B located outside the visible area 41, the CPU 11 of the wearable terminal device 10 in this embodiment causes the display 14 to perform display so as to indicate in a prescribed manner the existence of the second virtual image 30B. Thus, the user is able to easily recognize the presence of the second virtual image 30B outside the visible area 41 without having to change his/her position.

For example, regarding areas inside and outside the visible area 41, when an image output from the camera 154 is displayed on an external device, the area displayed by the external device may be considered as being inside the visible area 41 and the area not displayed by the external device may be considered as being outside the visible area 41. In other words, the visible area 41 recognized by the wearable terminal device 10 may match the image output from the camera 154 displayed on the external device. If the viewing angle (angle of view) of the camera 154 and the viewing angle of a human do not match, the visible area 41 recognized by the wearable terminal device 10 does not need to be the same as the image output from the camera 154. In other words, if the viewing angle (angle of view) of the camera 154 is wider than the viewing angle of a human, the visible area 41 recognized by the wearable terminal device 10 may be an area corresponding to a portion of the image output from the camera 154 that is displayed on the external device. The human visual field can be broadly classified into the effective visual field, which is the range within which humans are able to maintain high visual acuity and recognize detailed objects (generally, the effective visual field when using both the left and right eyes is approximately 60 degrees horizontally and 40 degrees vertically), and the peripheral visual field, which is the range outside the effective visual field (the range in which detailed objects cannot be recognized). The visible area 41 may be defined so as to correspond to the effective field of view, or may be defined so as to correspond to a field of view including the peripheral field of view (generally, around 200 degrees horizontally and 130 degrees vertically when both the left and right eyes are used). The visible area 41 may be defined so as to correspond to the effective field of view or may be defined so as to correspond to a field of view including the peripheral field of view, and the CPU 11 of the wearable terminal device 10 may change the visible area 41 so as to be based on either of these definitions as appropriate, depending on prescribed conditions (such as a mode change initiated by a prescribed operation performed by the user).

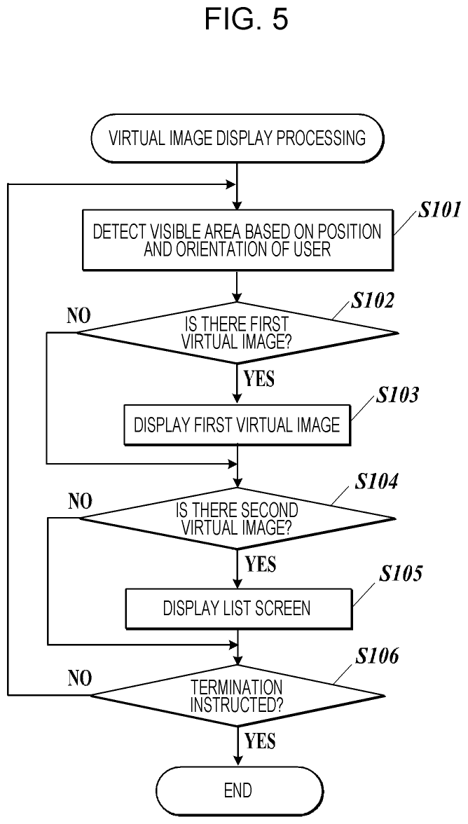

Next, an example of display indicating the presence of a second virtual image 30B will be described while referring to FIGS. 5 to 26.

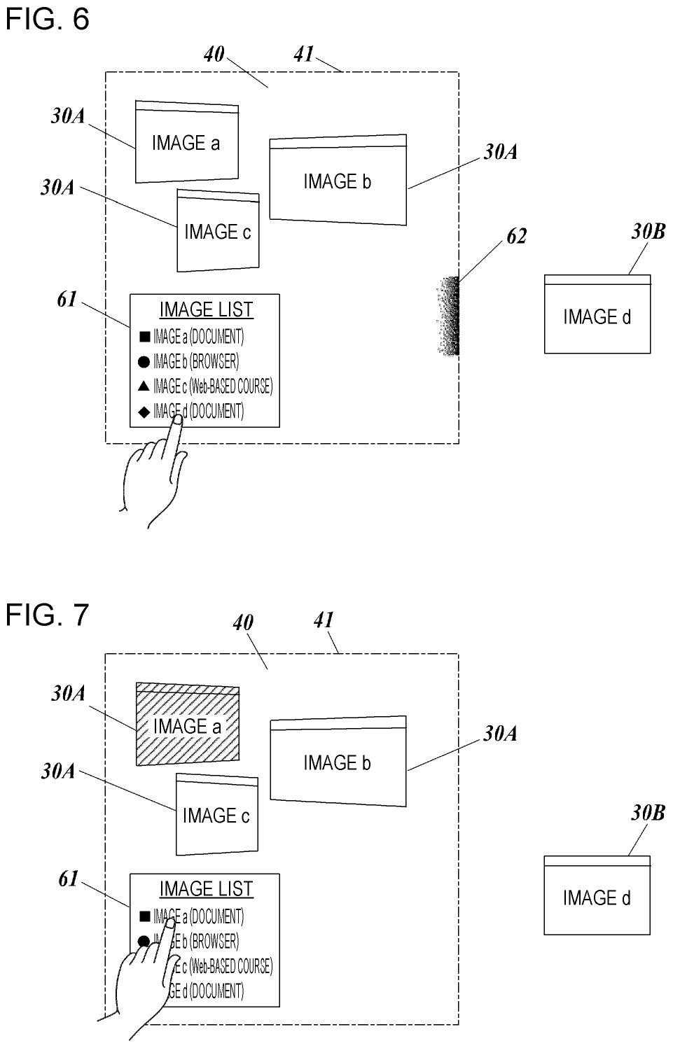

First, a control procedure performed by the CPU 11 for virtual image display processing according to an aspect of the present disclosure will be described while referring to the flowchart in FIG. 5. The virtual image display processing in FIG. 5 includes at least a feature of displaying a prescribed list screen 61 (refer to FIG. 6) when there is a second virtual image 30B.

When the virtual image display processing illustrated in FIG. 5 starts, the CPU 11 detects the visible area 41 based on the position and orientation of the user (Step S101).

The CPU 11 determines whether there is a first virtual image 30A whose display position is defined inside the detected visible area 41 (Step S102), and if there is determined to be a first virtual image 30A (“YES” in Step S102), the CPU 11 causes the display 14 to display the first virtual image 30A (Step S103).

When Step S103 is complete, or when there is determined to be no first virtual image 30A in Step S102 (“NO” in Step S102), the CPU 11 determines whether there is a second virtual image 30B whose display position is defined outside the visible area 41 (Step S104). When there is determined to be a second virtual image 30B (“YES” in Step S104), the CPU 11 causes the display 14 to display a prescribed list screen 61.

When Step S105 is complete, or when there is determined to be no second virtual image 30B in Step S104 (“NO” in Step S104), the CPU 11 determines whether an instruction has been issued to terminate the display operation performed by the wearable terminal device 10 (Step S106). If no such instruction is determined to have been issued (“NO” in Step S106), the CPU 11 returns the processing to Step S101, and if such an instruction is determined to have been issued (“YES” in Step S106), the virtual image display processing is terminated.

Next, a specific operation of displaying the list screen 61 in Step S105 will be described.

As illustrated in FIG. 6, when there is a second virtual image 30B located outside the visible area 41, the CPU 11 causes the display 14 to display a list screen 61 containing a list of first virtual images 30A and a second virtual image 30B. In FIG. 6, three first virtual images 30A (images a to c) are displayed inside the visible area 41, and one second virtual image 30B (image d) is located outside the visible area 41. In the state illustrated in FIG. 6, the image d is not displayed on the display 14. In this case, the list screen 61 listing the images a to d is displayed in the visible area 41. This allows the user to be able to easily recognize the presence of the image d outside the visible area 41.

The list screen 61 may be displayed in any display mode so long as the user can recognize that the images a to d are listed. For example, the list screen 61 may display the file names of the images a to d, icons representing the images a to d, scaled-down representations of the images a to d, or a combination of these modes.

The position at which the list screen 61 is displayed may be fixed on the display 14 regardless of the position and orientation of the user in the space 40. In other words, the list screen 61 has no set (fixed) display position in the space 40 and may continue to be displayed at a prescribed position on the display surface of the visor 141 even when the visible area 41 moves. This allows the user to always see the list screen 61 regardless of his or her position and orientation.

As illustrated in FIG. 6, in response to a prescribed operation performed on one second virtual image 30B (here, image d) contained in the list screen 61, the CPU 11 may cause the display 14 to display an indicator 62 indicating the direction in which the second virtual image 30B is located. By displaying the indicator 62, the user is able to intuitively grasp the direction in which the image d is located. The above prescribed operation is, in FIG. 6, a finger tap on the entry for the image d in the list screen 61, but it is not limited to this operation, and may be, for example, selecting the entry for the image d using the pointer 52. The shape and display mode of the indicator 62 are not limited to those illustrated in FIG. 6, and any shape and display mode are acceptable so long as the direction in which the second virtual image 30B is located can be indicated.

As illustrated in FIG. 7, the CPU 11 may change the display mode of one of the virtual images 30 included in the list screen 61 (in this case, image a) in accordance with a prescribed operation performed for that one virtual image 30. Specifically, the CPU 11 changes the color of the image a (for example, darkens the color) and displays the image a in a highlighted manner in accordance with an operation of tapping the entry for the image a in the list screen 61. This allows the user to intuitively grasp the position of the image a. The change in display mode is not limited to highlighted display and, for example, the size of the virtual image 30 may be changed, the image may blink, the orientation of the virtual image 30 may be changed so as to directly face the user, the virtual image 30 may be moved to a more visible position nearer the user, or a prescribed mark may be displayed in the vicinity of the virtual image 30. The above prescribed operation may be an operation such as selecting an entry in the list screen 61 using the pointer 52. When an operation is performed on the entry for the second virtual image 30B in the list screen 61, the display mode of the second virtual image 30B may be changed. This allows the user to easily recognize the second virtual image 30B when the second virtual image 30B enters the visible area 41.

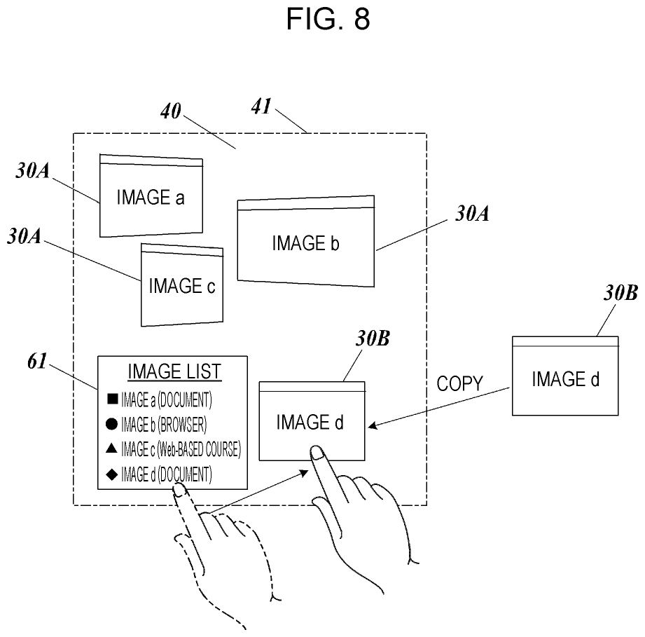

As illustrated in FIG. 8, in accordance with a prescribed copying operation performed on one of the virtual images 30 (in this case, image d) included in the list screen 61, the CPU 11 may copy the virtual image 30 and cause the display 14 to display the copied virtual image 30. Here, the copying operation includes, for example, a dragging operation and a dropping operation performed on an entry for one of the virtual images 30 included in the list screen 61. In this case, the CPU 11 copies the one virtual image 30 and causes the display 14 to display the virtual image 30 at the position where the dropping operation was performed. What is copied here is not the entry for the image d contained in the list screen 61 (file name, icon, and so on), but the image d itself, which is located outside the visible area 41. This allows the user to check the contents of the second virtual image 30B outside the visible area 41 without needing to change his or her position or orientation. In a case where the entry for the image d included in the list screen 61 includes at least part of the content of the image d itself (for example, a scaled-down image), the entry for the image d included in the list screen 61 may be copied (enlarged if necessary) in response to the dragging operation and the dropping operation. A target of the copying operation is not limited to the second virtual image 30B, and the copying operation may also be performed on the first virtual images 30A. For example, by copying a first virtual image 30A, which is located inside the visible area 41 but whose contents are difficult to check at a position far from the user, to a position nearer the user, the user is able to more easily check the contents of the first virtual image 30A.

When the CPU 11 accepts an operation for editing one of the copied virtual images 30 (in this case, image d), the CPU 11 may reflect the content of the edit made by the operation in the copied source virtual image 30, that is, the image d, which is located outside the visible area 41. This allows the user to edit the contents of the second virtual image 30B outside the visible area 41 without needing to change his or her position or orientation.

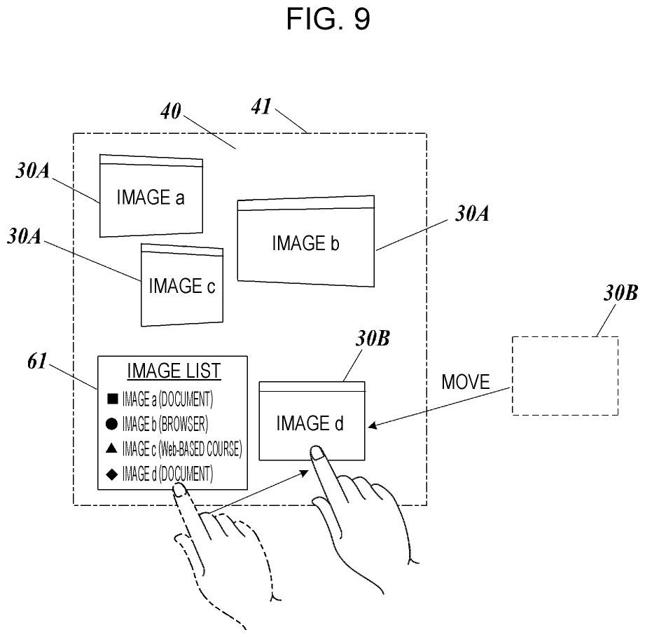

As illustrated in FIG. 9, in accordance with a prescribed moving operation performed on one virtual image 30 (here, image d) included in the list screen 61, the CPU 11 may move that one virtual image 30 to a position in accordance with the moving operation. Here, the moving operation includes, for example, dragging and dropping operations performed on an entry for one of the virtual images 30 included in the list screen 61. In this case, the CPU 11 moves the one virtual image 30 to the position where the dropping operation was performed. What is moved here is not the entry for the image d contained in the list screen 61 (file name, icon, and so on), but the image d itself, which is located outside the visible area 41. This allows the user to check the contents of the second virtual image 30B outside the visible area 41 without needing to change his or her position or orientation. A target of the moving operation is not limited to the second virtual image 30B, and may also be performed on the first virtual images 30A. For example, by moving a first virtual image 30A, which is located inside the visible area 41 but whose contents are difficult to check at a position far from the user, to a position nearer the user, the user is able to more easily check the contents of the first virtual image 30A. The moved virtual image 30 may be returned to its original position in accordance with a prescribed operation.

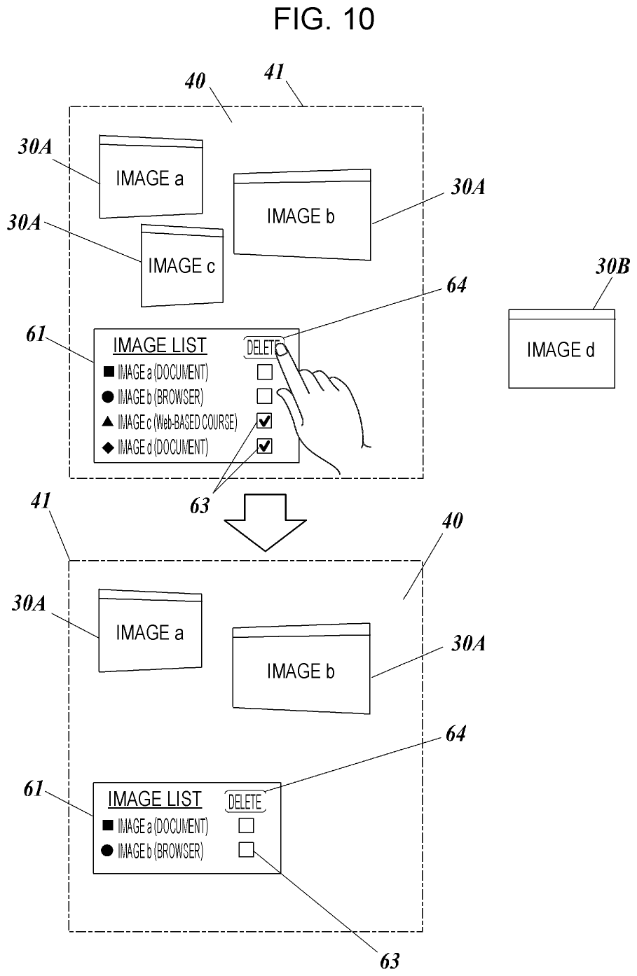

As illustrated in FIG. 10, the CPU 11 may delete selected virtual images 30 from the space 40 in accordance with a delete operation that includes an operation of selecting one or more virtual images 30 (here, images c and d) included in the list screen 61. Specifically, in the list screen 61 illustrated in the upper part in FIG. 10, check boxes 63 are displayed to the right of respective entries to allow selection of the virtual images 30 for those entries. By selecting the delete button 64 after checking the check boxes 63 for the virtual images 30 to be deleted, the checked virtual images 30 can be deleted (erased) from the space 40 in one batch, as illustrated in the lower part of FIG. 10. This allows the user to simply delete unwanted virtual images 30 without having to move the images to positions where the images can be manipulated. The check boxes 63 and the delete button 64 may be displayed when called by the user. The check boxes 63 and the delete button 64 may be displayed when the turning off of the wearable terminal device 10 is instructed, and the user may be asked whether or not to delete each virtual image 30. The virtual images 30 included in the list screen 61 that were not checked (not selected) may be deleted from the space 40.

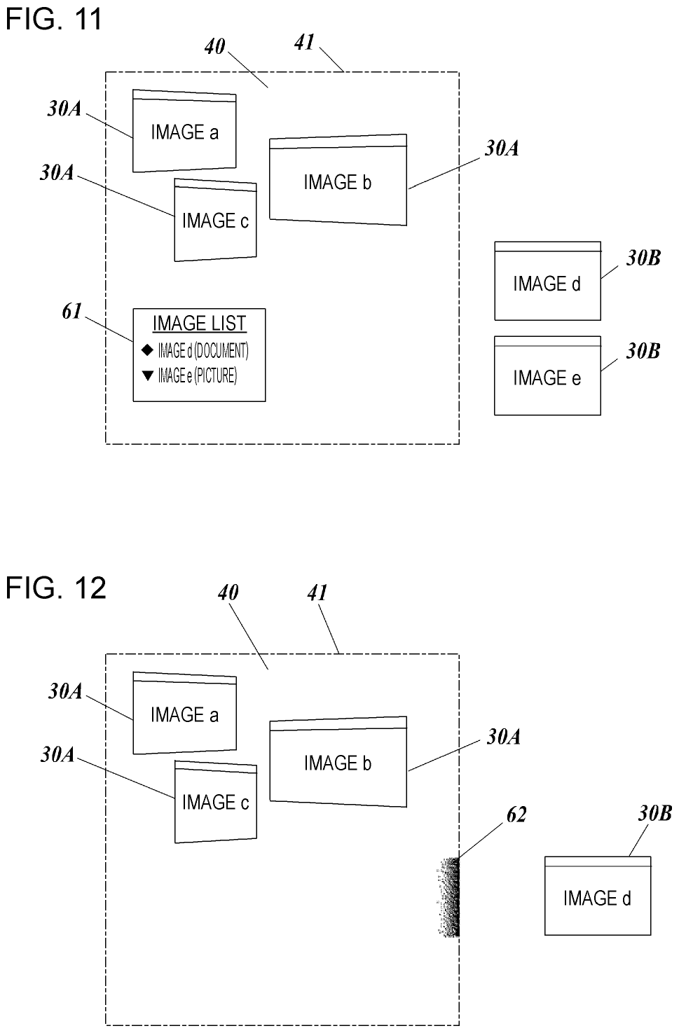

As illustrated in FIG. 11, when there are second virtual images 30B (here, images d and e) located outside the visible area 41, the CPU 11 may cause the display to display a list screen 61 containing a list of the second virtual images 30B (here, images d and e). In other words, only the second virtual images 30B (images d and e) that are not visible may be listed on the list screen 61 without listing the first virtual images 30A (images a to c) that are visible in the visible area 41. This allows the second virtual images 30B, which are located outside the visible area 41, to be easily recognized.

Instead of in the manner illustrated in FIGS. 6 to 11, an indicator 62 indicating the direction in which a second virtual image 30B (here, image d) is located may be displayed on the display 14, as illustrated in FIG. 12, rather than displaying the list screen 61. Displaying the indicator 62 in this manner allows the user to recognize the presence of the second virtual image 30B. In other words, the display of the indicator 62 is one form of “indicating in a prescribed manner the existence of the second virtual image 30B”. The shape and display mode of the indicator 62 are not limited to those illustrated in FIG. 12, and any shape and display mode are acceptable so long as the direction in the second virtual image 30B is located can be indicated.

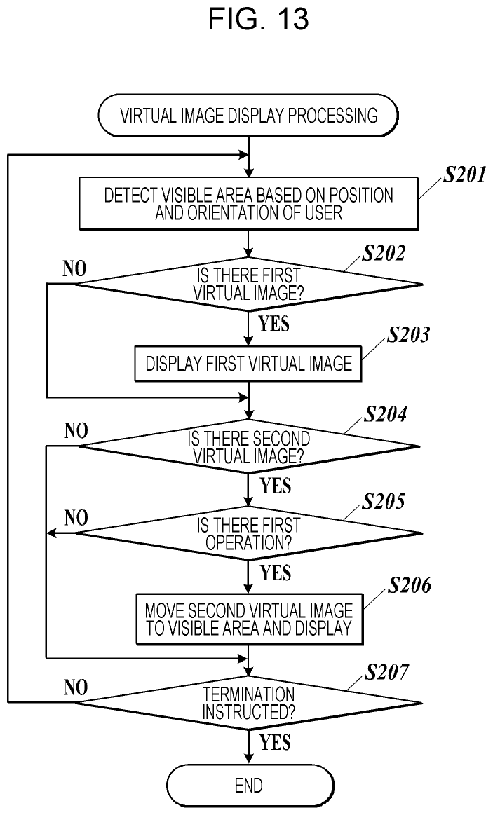

Next, a control procedure performed by the CPU 11 for virtual image display processing according to another aspect of the present disclosure will be described while referring to the flowchart in FIG. 13. The virtual image display processing in FIG. 13 includes at least the feature of displaying a second virtual image 30B on the display 14 (i.e., inside the visible area 41) when there is a second virtual image 30B and a first operation is performed by the user.

When the virtual image display processing illustrated in FIG. 13 starts, the CPU 11 detects the visible area 41 based on the position and orientation of the user (Step S201).

The CPU 11 determines whether there is a first virtual image 30A whose display position is defined inside the detected visible area 41 (Step S202), and if there is determined to be a first virtual image 30A (“YES” in Step S202), the CPU 11 causes the display 14 to display the first virtual image 30A (Step S203).

When Step S203 is complete, or when there is determined to be no first virtual image 30A in Step S202 (“NO” in step S202), the CPU 11 determines whether there is a second virtual image 30B whose display position is defined outside the visible area 41 (Step S204).

When there is determined to be a second virtual image 30B (“YES” in Step S204), the CPU 11 determines whether a prescribed first operation has been performed (Step S205). When it is determined that the first operation has been performed (“YES” in Step S205), the CPU 11 moves the second virtual image 30B to the visible area 41 and causes the display 14 to display the second virtual image 30B (Step S206).

Once Step S206 is complete, when there is determined to be no second virtual image 30B in Step S204 (“NO” in Step S204) or when the first operation is determined not to have been performed in Step S205 (NO″ in Step S205), the CPU 11 determines whether or not an instruction to terminate the display operation performed by the wearable terminal device 10 has been issued (Step S207). If no such instruction is determined to have been issued (“NO” in Step S207), the CPU 11 returns the processing to Step S201, and if such an instruction is determined to have been issued (“YES” in Step S207″), the CPU 11 terminates the virtual image display processing.

Next, a specific operation of displaying the second virtual image 30B in Step S206 will be described.

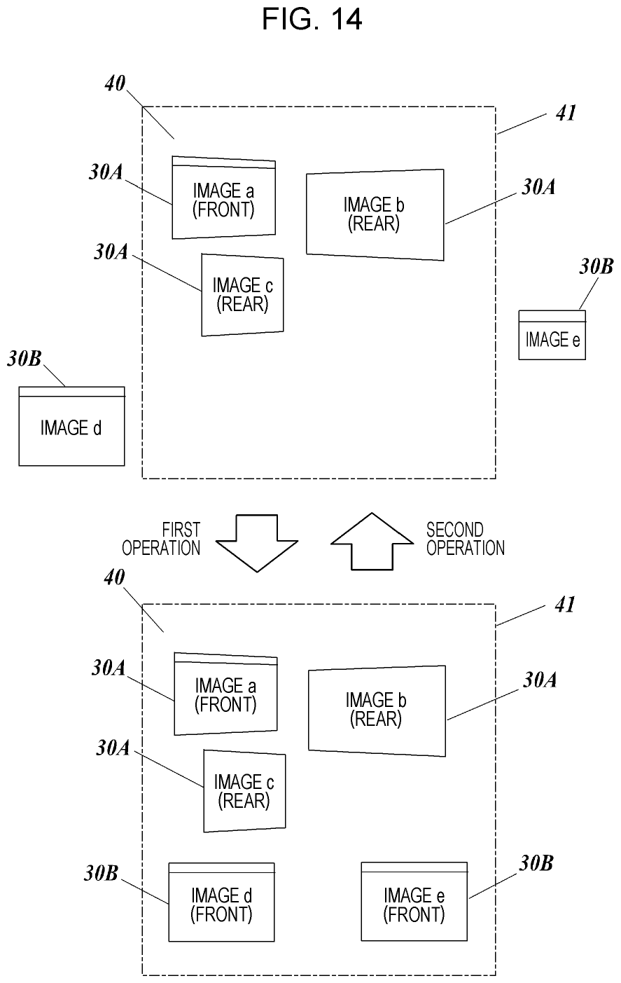

As illustrated in FIG. 14, the CPU 11 causes the display 14 to display the second virtual images 30B (here, images d and e) based on the first operation. In other words, the CPU 11 moves the second virtual images 30B to the inside of the visible area 41. This enables the user to recognize that the second virtual images 30B are outside the visible area 41 without having to change his or her position or orientation, and also allows the user to check the contents of the second virtual images 30B. The above first operation can be any predetermined operation. For example, the first operation may be an operation in which a gesture is made in which the hand is held in a clenched first gesture with the pointer 52 not overlapping any of the operation targets. The positions of the second virtual images 30B after being moved can be set as desired. For example, the second virtual image 30B (image d in FIG. 14) which was on the left side of the visible area 41 may be displayed in the left half of the visible area 41, and the second virtual image 30B (image e in FIG. 14) which was on the right side of the visible area 41 may be displayed in the right half of the visible area 41.

Here, the CPU 11 may display the second virtual images 30B at positions within a prescribed operation target range from the user's position in the visible area 41. The operation target range can be defined as appropriate. For example, the operation target range may be a range within which operations can be performed using the pointer 52 without using the virtual line 51, or may be a distance range set by the user in advance.

The CPU 11 may change the size of a second virtual image 30B (in this case, image e) and cause the display 14 to display the second virtual image 30B. As illustrated in FIG. 14, the image e may be enlarged and then moved to the visible area 41 if the image e is small and difficult to see prior to being moved. The size of the multiple second virtual images 30B that have been moved may be made uniform.

The CPU 11 may return at least one second virtual image 30B to its original position if a second operation is performed when the second virtual image 30B is displayed on the display 14 based on the first operation. This allows a second virtual image 30B to be easily returned to its original position after the contents of the second virtual image 30B have been checked. The above second operation may be the same operation as the first operation, or the second operation may be determined in advance as a different operation from the first operation. For example, the second operation may be a finger flicking gesture. In the case where a first virtual image 30A has been moved within the visible area 41 when the first operation was performed, the first virtual image 30A may be returned to its original position in response to the second operation. Any virtual image 30 may be selected, and the selected virtual image 30 may be returned to its original position in response to the second operation. Alternatively, an unselected virtual image 30 may be returned to its original position.

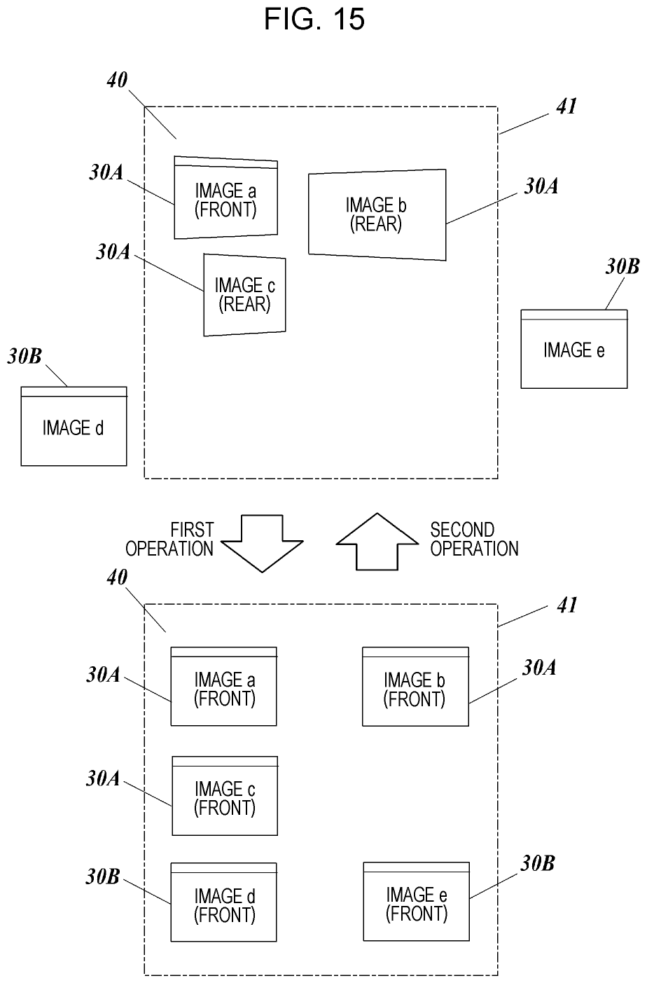

As illustrated in FIG. 15, the CPU 11 may align the first virtual images 30A and second virtual images 30B in a prescribed manner. Here, the first virtual images 30A and second virtual images 30B are arranged in a matrix pattern. The arrangement is not limited to this form, and the images may instead be arranged in a single row for example. This makes each of the virtual images 30 easier to see.

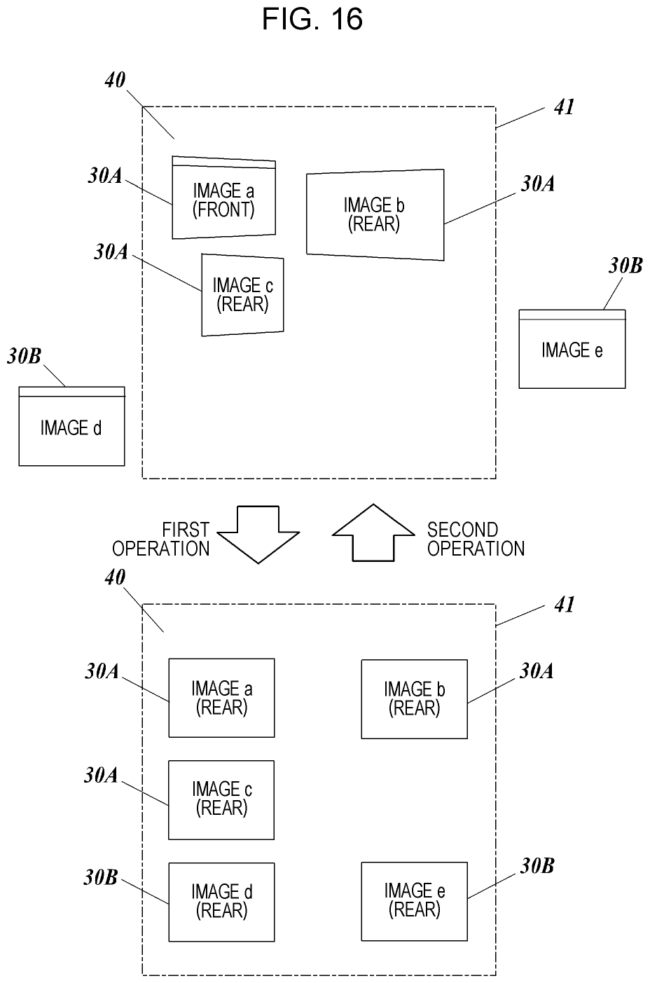

The CPU 11 may cause the display 14 to display each first virtual image 30A and second virtual image 30B so that one out of the front surface (first surface) and the rear surface (second surface) faces the user. In FIG. 15, the second virtual images 30B are displayed with their front surfaces facing the user and the orientations of first virtual images 30A are changed. This allows the user to see the content on the front surface of each of the virtual images 30. Alternatively, as illustrated in FIG. 16, the first virtual images 30A and the second virtual images 30B may be displayed with their rear surfaces facing the user. In this way, a virtual image 30 can be shown to another user on the opposite side of the virtual image 30.

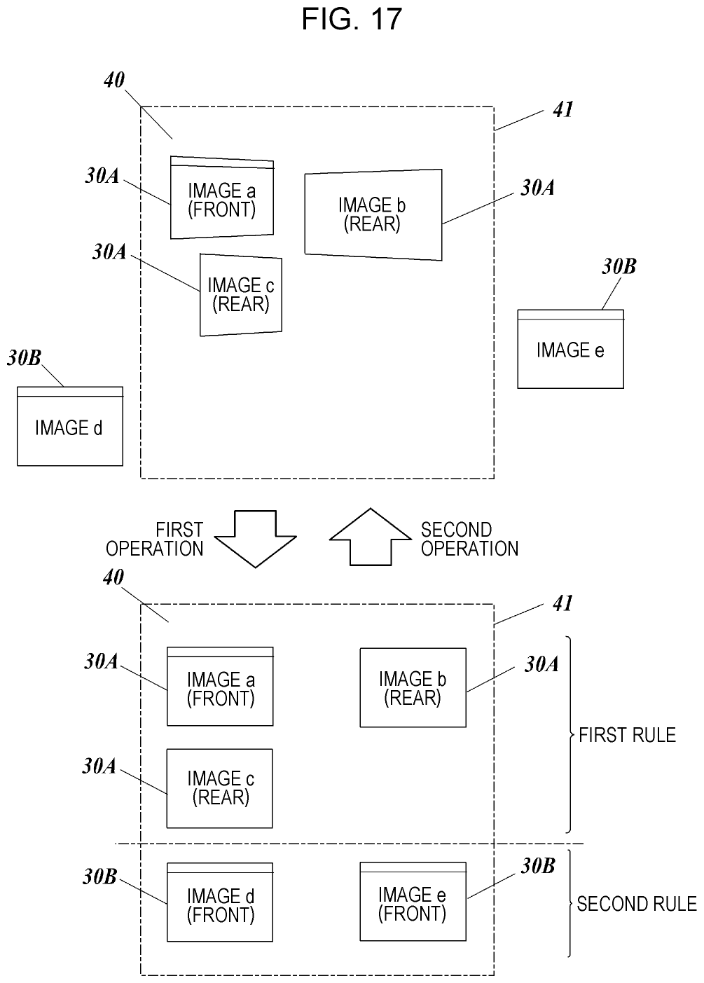

As illustrated in FIG. 17, the CPU 11 may cause the display 14 to display the first virtual images 30A in a manner that follows a first rule and display the second virtual images 30B in a manner that follows a second rule, which is different from the first rule. In the example in FIG. 17, the first rule is to “leave the front and rear surfaces of the virtual images 30 as they are without being flipped, but adjust the virtual images 30 so as to be oriented so as to directly face the user. The second rule is to “display the images so that the front surfaces face the user”. The first rule and the second rule are not limited to the above examples. This allows the first virtual images 30A and second virtual images 30B to be displayed in a manner desired by the user.

After displaying the second virtual images 30B on the display 14, the CPU 11 may change the surface of at least one of the virtual images 30 that is displayed in accordance with a prescribed operation. For example, after the first virtual images 30A and the second virtual images 30B have been displayed with their front surfaces and rear surfaces displayed in a mixed manner as illustrated in the lower part of FIG. 17, the display surfaces may be flipped so that the front surfaces of all virtual images 30 face the user as illustrated in the lower part of FIG. 15, in accordance with a prescribed operation. A transition of the display in response to a prescribed operation is not limited to the above transition, and for example, a transition may occur between the states illustrated in any two of the lower parts of the drawings in FIGS. 14 to 17. This allows a transition to be easily made to a display mode desired by the user.

The CPU 11 may also arrange the first virtual images 30A and second virtual images 30B in an order based on prescribed conditions. For example, the virtual images 30 may be arranged according to an order based on the names of the virtual images 30, an order based on the display sizes of the virtual images 30, an order based on an attribute of the virtual images 30, an order based on the distances between the display positions of the virtual images 30 and the position of the user, an order based on the surfaces (front or rear surfaces) of the virtual images 30 facing the user, and so on. The arrangement may be in the form of a matrix pattern like in FIG. 15, or in a row. The images may be arranged in a depth direction so that at least parts of multiple virtual images 30 are superimposed with each other as seen by the user. This makes it easier for the user to find a desired virtual image 30.

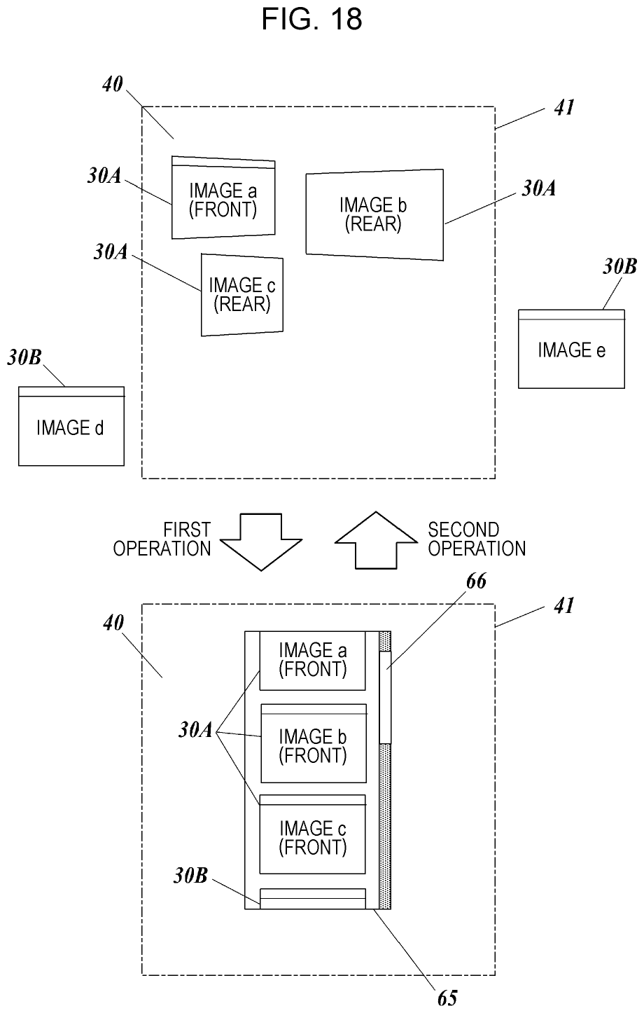

As illustrated in FIG. 18, when multiple second virtual images 30B are displayed on the display 14, the CPU 11 may cause the display 14 to display a scrolling screen 65 that allows any of the multiple second virtual images 30B to be displayed by performing a scrolling operation. In the scrolling screen 65 illustrated in FIG. 18, the first virtual images 30A and the second virtual images 30B are arranged in a column in the vertical direction, and a portion of this arrangement is displayed. The portion displayed on the scrolling screen 65 can be changed by moving a scroll bar 66 up or down. Here, the first virtual images 30A are displayed on the scrolling screen 65 along with the second virtual images 30B, but alternatively just the second virtual images 30B may be displayed on the scrolling screen 65. In the scrolling screen 65, the virtual images 30 may be arranged in an order based on prescribed conditions as described above. By displaying such a scrolling screen 65, the second virtual images 30B can be easily checked even when there are a large number of second virtual images 30B.

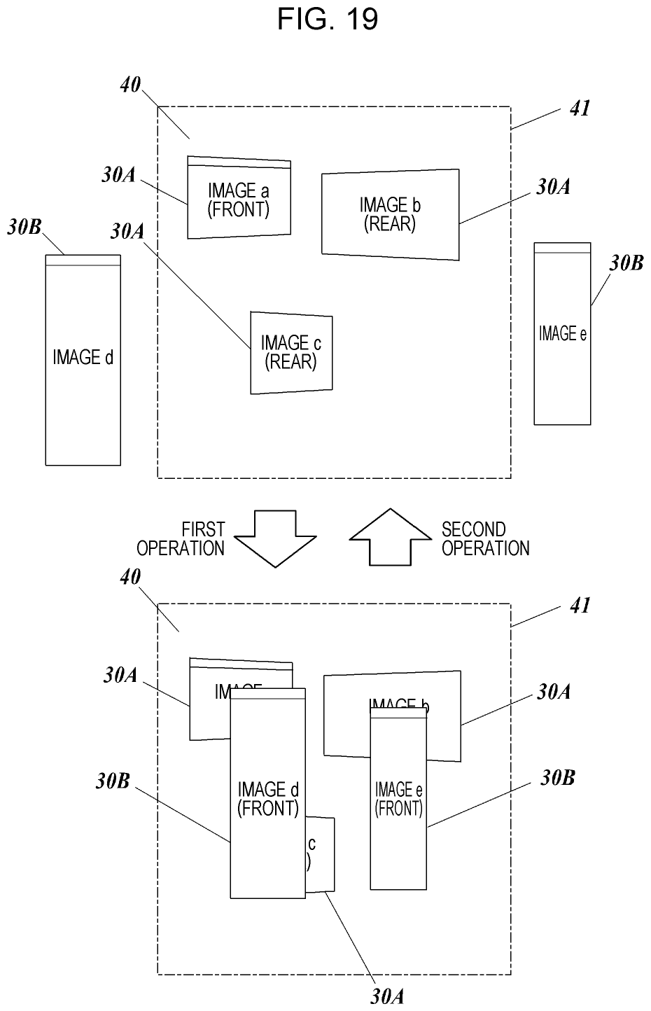

As illustrated in FIG. 19, the CPU 11 may cause the display 14 to display the second virtual images 30B so as to overlap at least portions of the first virtual images 30A. This allows the second virtual images 30B to be displayed in an easily visible state while maintaining the display states of the first virtual images 30A.

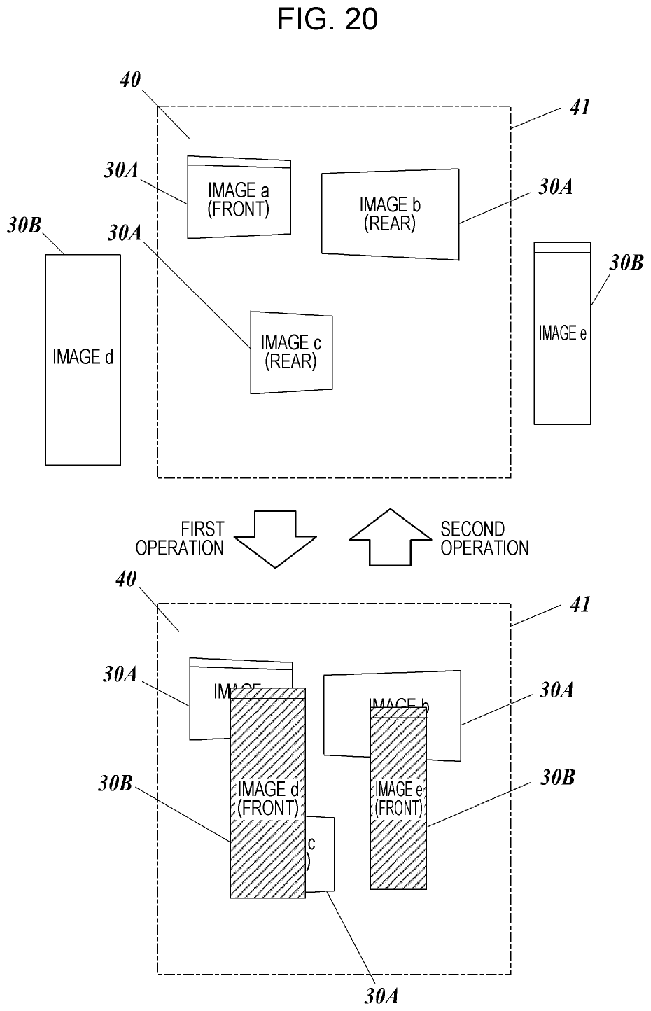

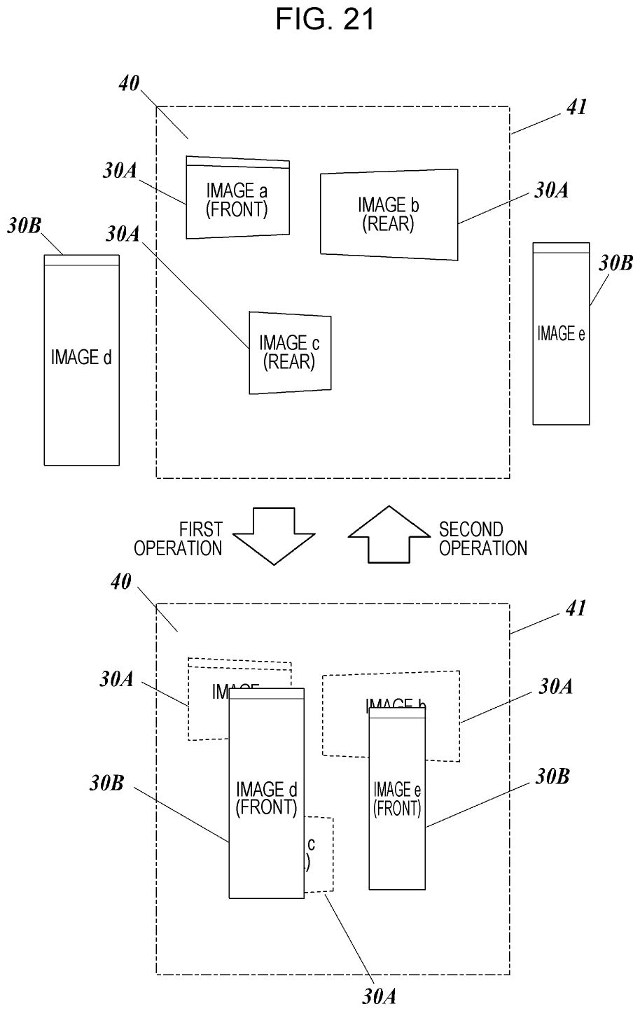

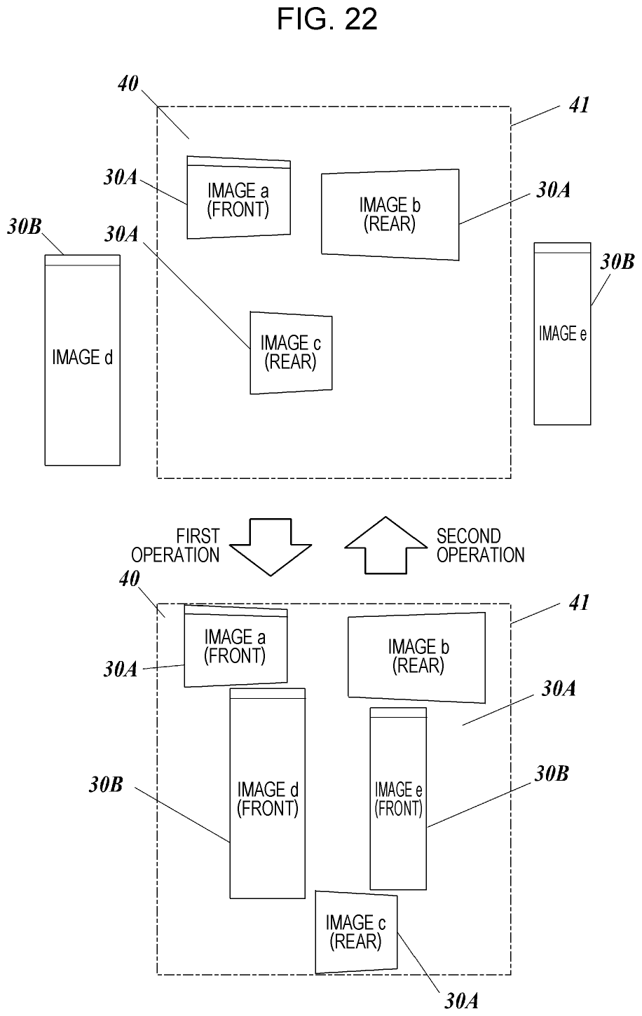

As illustrated in FIG. 20, the CPU 11 may cause the display 14 to display either the first virtual images 30A or the second virtual images 30B in a prescribed emphasized manner that makes one stand out from the other. Thus, the first virtual images 30A and the second virtual images 30B can be more easily distinguished between. FIG. 20 illustrates an example in which the second virtual images 30B are highlighted by changing the color of the second virtual images 30B (for example, by making the color darker), thereby making the second virtual images 30B stand out from the first virtual images 30A. Conversely, the first virtual images 30A may be made to stand out from the second virtual images 30B. Emphasized display is not limited to highlighted display such as that illustrated in FIG. 20 and, for example, the size of the virtual images 30 may be changed, the images may blink, the orientation of the virtual images 30 may be changed so as to directly face the user, the virtual images 30 may be moved to more visible positions nearer the user, or a prescribed mark may be displayed in the vicinity of the virtual images 30. The emphasized display may be performed in FIGS. 14 to 18, as well as in FIGS. 21 and 22 referenced below.

As illustrated in FIG. 21, the CPU 11 may cause the display 14 to display either the first virtual images 30A or the second virtual images 30B in a prescribed suppressed manner in which one is less noticeable than the other. Thus, the first virtual images 30A and the second virtual images 30B can be more easily distinguished between. FIG. 21 illustrates an example of making the first virtual images 30A less noticeable than the second virtual images 30B by increasing the transparency of the first virtual images 30A. Conversely, the second virtual images 30B may be made less noticeable than the first virtual images 30A. The suppressed manner is not limited to the display mode in which the transparency is increased as illustrated in FIG. 21, and may be, for example, making the virtual images 30 smaller or temporarily erasing the virtual images 30. The suppressed display may be performed in FIGS. 14 to 18, as well as in FIG. 22 referenced below.

As illustrated in FIG. 22, the CPU 11 may change the positions of virtual images 30 other than specific virtual images 30 in order to avoid those specific virtual images 30. For example, the positions of the first virtual images 30A may be changed so that the first virtual images 30A do not overlap the second virtual images 30B as seen by the user. The position of each virtual image 30 may be changed so that none of the virtual images 30 overlap as seen by the user. Thus, the visibility of the virtual images 30 can be improved.

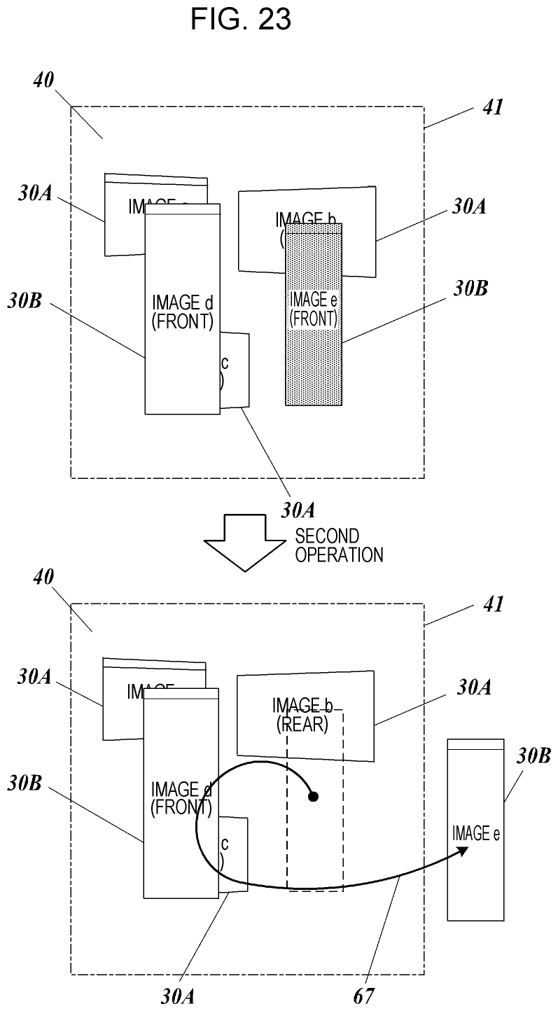

As illustrated in FIG. 23, the CPU 11 may return only a specific virtual image 30 to its original position when the second operation described above is performed. Here, the specific virtual image 30 may be, for example, a virtual image 30 specified by the user, or may be a virtual image 30 that meets a prescribed condition (for example, a second virtual image 30B that was outside the visible area 41 before being moved). The specific virtual image 30 may be a first virtual image 30A that was originally inside the visible area 41 and whose position was changed. A specific virtual image 30 may be displayed in an emphasized manner as illustrated in FIG. 23. When the second operation is performed, the CPU 11 may move a second virtual image 30B to its original position along a path 67 that passes in front of the user (in front of his or her eyes). This allows the user to more easily recognize that the second virtual image 30B will return to its original position. This also allows the user to recognize which second virtual image 30B will return to its original position.

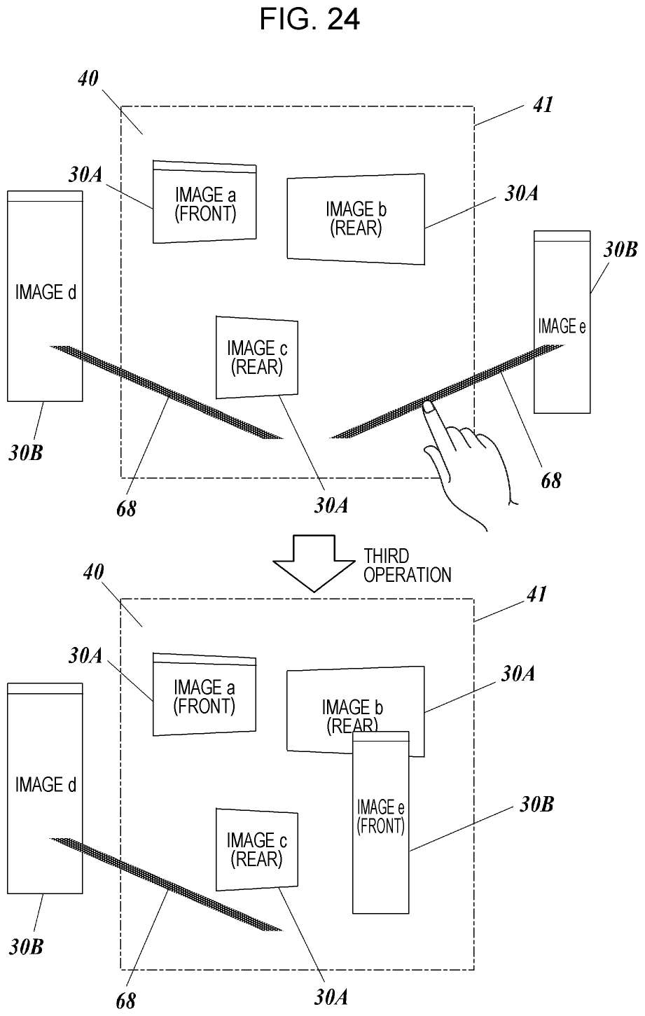

As illustrated in FIG. 24, the CPU 11 may cause the display 14 to display lines 68 that link the second virtual images 30B, which have been returned to their original positions, to prescribed positions in the visible area 41. The lines 68 may be straight or may be curved in order to increase the distance traveled through the inside of the visible area 41. Displaying such lines 68 allows the fact that there are second virtual images 30B that have returned to their original positions and the directions of the second virtual images 30B to be more easily recognized.

As illustrated in the lower part of FIG. 24, the CPU 11 may cause the display 14 to display a second virtual image 30B to which a line 68 is tied in response to a prescribed operation performed on the line 68 (third operation). This allows a desired second virtual image 30B, out of the second virtual images 30B which have been returned to outside the visible area 41, to be easily displayed again in order to check its contents. The above third operation can be, but is not limited to, for example, an operation of touching 68 with a finger or selecting 68 using the pointer 52.

Each of the operations described with reference to FIGS. 6 to 24 can also be applied when the first virtual images 30A and the second virtual images 30B are located in separate spaces. Hereinafter, an example will be described in which there are three first virtual images 30A (images a to c) whose positions are defined a first space 40A and two second virtual images 30B (images d and e) whose positions are defined a second space 40B, which is separate from the first space 40A. In such an example, the CPU 11 may perform display, on the display 14, to indicate the presence of the second virtual images 30B located in the second space 40B when the device (user) is located in the first space 40A. In addition, the CPU 11 may perform display, on the display 14, to indicate the presence of the second virtual images 30B located in the second space 40B when the device (user) has moved from the second space 40B to the first space 40A. This allows the user to easily recognize the presence of the second virtual images 30B in a space before moving when the user is going to move from one space to another, such as when the user is going to move from one room to another.

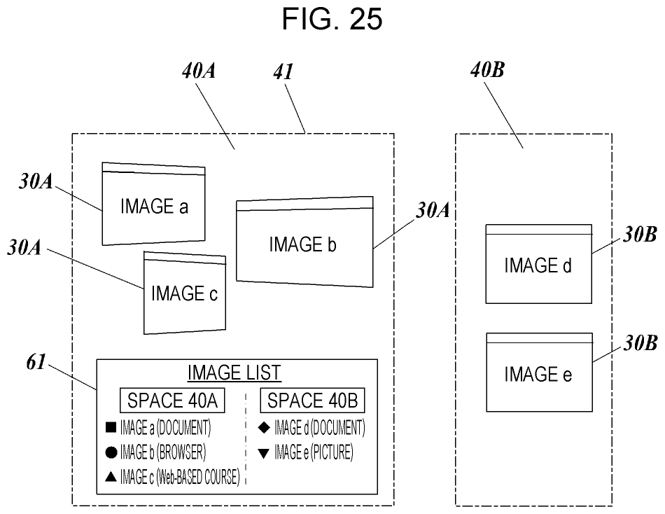

Specifically, as illustrated in FIG. 25, the CPU 11 may cause the display 14 to display the list screen 61 containing a list of the second virtual images 30B (here, images d and e) located in the second space 40B. If there is also a second virtual image 30B outside the visible area 41 in the first space 40A, the second virtual image 30B may also be displayed on the list screen 61.

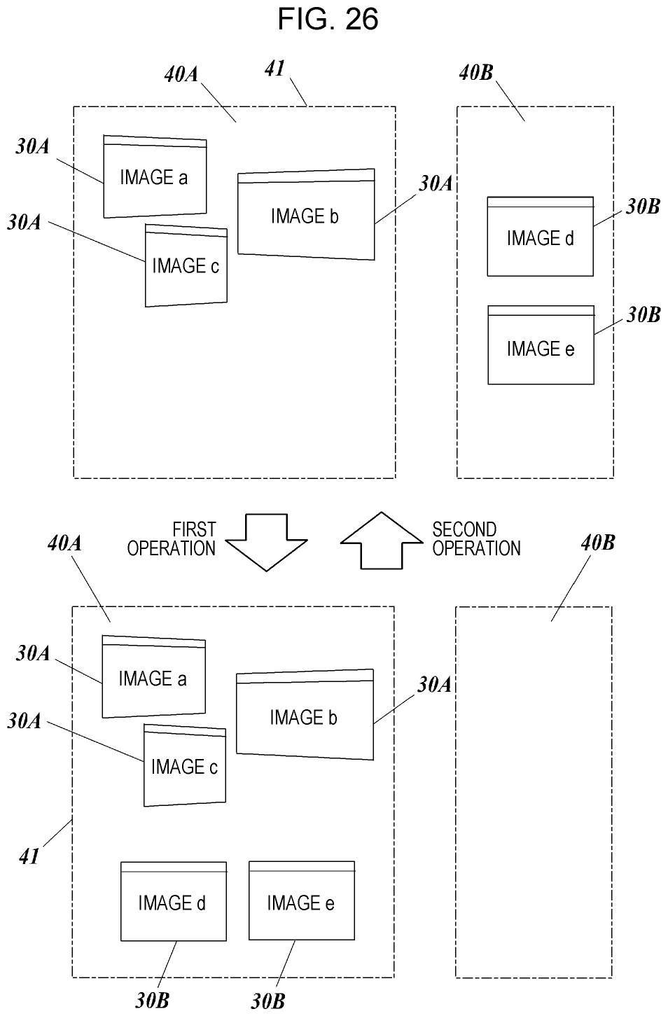

As illustrated in FIG. 26, the CPU 11 may cause the display 14 to display the second virtual images 30B that are in the second space 40B (here, images d and e) based on the first operation. This allows the user to check the contents of the second virtual images 30B in the second space 40B while the user is in the first space 40A.

### Second Embodiment

Next, the configuration of a display system 1 according to a Second Embodiment will be described. The Second Embodiment differs from the First Embodiment in that an external information processing apparatus 20 executes part of the processing that is executed by the CPU 11 of the wearable terminal device 10 in the First Embodiment. Hereafter, differences from the First Embodiment will be described, and description of common points will be omitted.

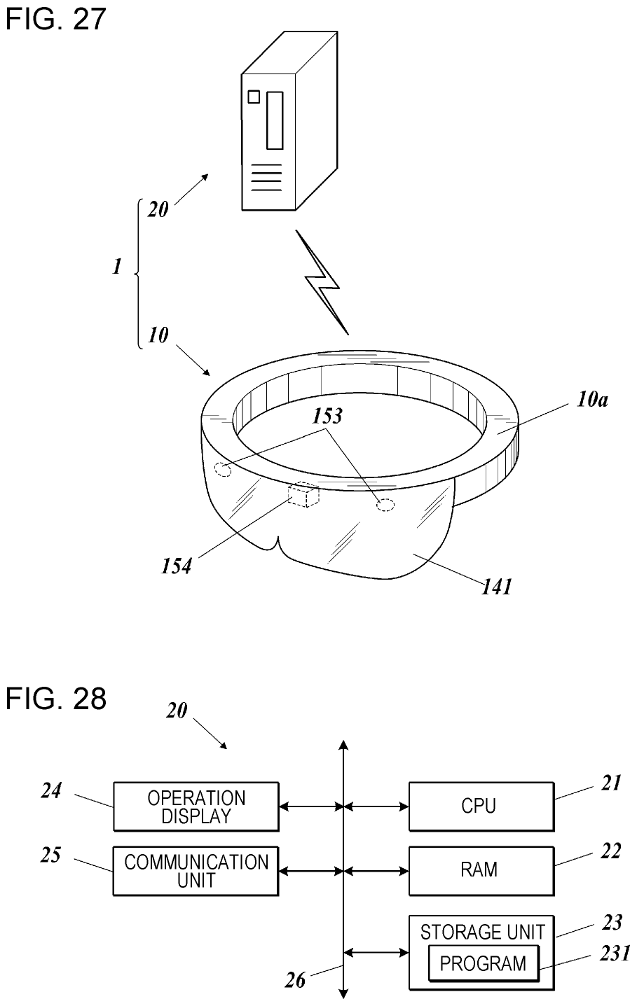

As illustrated in FIG. 27, the display system 1 includes the wearable terminal device 10 and the information processing apparatus 20 (server) connected to the wearable terminal device 10 so as to be able to communicate with the wearable terminal device 10. At least part of a communication path between the wearable terminal device 10 and the information processing apparatus 20 may be realized by wireless communication. The hardware configuration of the wearable terminal device 10 can be substantially the same as in the First Embodiment, but the processor for performing the same processing as that performed by the information processing apparatus 20 may be omitted.

As illustrated in FIG. 28, the information processing apparatus 20 includes a CPU 21, a RAM 22, a storage unit 23, an operation display 24, and a communication unit 25, which are connected to each other by a bus 26.

The CPU 21 is a processor that performs various arithmetic operations and controls overall operation of the various parts of the information processing apparatus 20. The CPU 21 reads out and executes a program 231 stored in storage unit 23 in order to perform various control operations.

The RAM 22 provides a working memory space for the CPU 21 and stores temporary data.

The storage unit 23 is a non-transitory recording medium that can be read by the CPU 21 serving as a computer. The storage unit 23 stores the program 231 executed by the CPU 21 and various settings data. The program 231 is stored in storage unit 23 in the form of computer-readable program code. For example, a nonvolatile storage device such as an SSD containing a flash memory or a hard disk drive (HDD) can be used as the storage unit 23.

The operation display 24 includes a display device such as a liquid crystal display and input devices such as a mouse and keyboard. The operation display 24 displays various information about the display system 1, such as operating status and processing results, on the display device. Here, the operating status of the display system 1 may include real-time images captured by the camera 154 of the wearable terminal device 10. The operation display 24 converts operations input to the input devices by the user into operation signals and outputs the operation signals to the CPU 21.

The communication unit 25 communicates with the wearable terminal device 10 and transmits data to and receives data from the wearable terminal device 10. For example, the communication unit 25 receives data including some or all of the detection results produced by the sensor unit 15 of the wearable terminal device 10 and information relating to user operations (gestures) detected by the wearable terminal device 10. The communication unit 25 may also be capable of communicating with devices other than the wearable terminal device 10.

In the thus-configured display system 1, the CPU 21 of the information processing apparatus 20 performs at least part of the processing that the CPU 11 of the wearable terminal device 10 performs in the First Embodiment. For example, the CPU 21 may perform three-dimensional mapping of the space 40 based on detection results from the depth sensor 153. The CPU 21 may detect the visible area 41 for the user in the space 40 based on detection results produced by each part of the sensor unit 15. The CPU 21 may also generate the virtual image data 132 relating to the virtual images 30 in accordance with operations performed by the user of the wearable terminal device 10. The CPU 21 may also detect the position and orientation of the user's hand (and/or fingers) based on images captured by the depth sensor 153 and the camera 154. The CPU 21 may also execute processing related to display of the list screen 61 and/or processing for moving the second virtual images 30B to the visible area 41.

The results of the above processing performed by the CPU 21 are transmitted to wearable terminal device 10 via the communication unit 25. The CPU 11 of the wearable terminal device 10 causes the individual parts of the wearable terminal device 10 (for example, display 14) to operate based on the received processing results. The CPU 21 may also transmit control signals to the wearable terminal device 10 in order to control the display 14 of the wearable terminal device 10.

Thus, as a result of executing at least part of the processing in the information processing apparatus 20, the configuration of the wearable terminal device 10 can be simplified and manufacturing costs can be reduced. In addition, using the information processing apparatus 20, which has a higher performance, allows various types of processing related to MR to be made faster and more precise. Thus, the precision of 3D mapping of the space 40 can be increased, the quality of display performed by the display 14 can be improved, and the reaction speed of the display 14 to operations performed by the user can be increased.

### Other Considerations

The above embodiments are illustrative examples, and may be changed in various ways. For example, in each of the above embodiments, the visor 141 that is transparent to light was used to allow the user to see the real space, but this configuration does not necessarily need to be adopted. For example, a visor 141 that blocks light may be used and the user may be allowed to see an image of the space 40 captured by the camera 154. In other words, the CPU 11 may cause the display 14 to display an image of the space 40 captured by the camera 154 and first virtual images 30A superimposed on the image of the space 40. With this configuration, MR, in which the virtual images 30 are merged with the real space, can be realized.

In addition, VR can be realized in which the user is made to feel as though he or she is in a virtual space by using images of a pre-generated virtual space instead of images captured in the real space by the camera 154. In this VR as well, the visible area 41 for the user is identified, and the part of the virtual space that is inside the visible area 41 and the virtual images 30 whose display positions are defined as being inside the visible area 41 are displayed. Therefore, similarly to as in the above embodiments, a display operation for indicating second virtual images 30B, which are outside the visible area 41, can be applied.

The wearable terminal device 10 does not need to include the ring-shaped body 10a illustrated in FIG. 1, and may have any structure so long as the wearable terminal device 10 includes a display that is visible to the user when worn. For example, a configuration in which the entire head is covered, such as a helmet, may be adopted. The wearable terminal device 10 may also include a frame that hangs over the ears, like a pair of glasses, with various devices built into the frame.

The virtual images 30 do not necessarily need to be stationary in the space 40 and may instead move within the space 40 along prescribed paths.

An example has been described in which the gestures of a user are detected and accepted as input operations, but the present disclosure is not limited to this example. For example, input operations may be accepted by a controller held in the user's hand or worn on the user's body.

Other specific details of the configurations and control operations described in the above embodiments can be changed as appropriate without departing from the intent of the present disclosure. The configurations and control operations described in the above embodiments can be combined as appropriate to the extent that the resulting combinations do not depart from the intent of the present disclosure.

### INDUSTRIAL APPLICABILITY

The present disclosure can be used in wearable terminal devices, programs, and display methods.

### REFERENCE SIGNS

1 display system
10 wearable terminal device
10a body
11 CPU (processor)
12 RAM
13 storage unit
131 program
132 virtual image data
14 display
141 visor (display member)
142 laser scanner
15 sensor unit
151 acceleration sensor
152 angular velocity sensor
153 depth sensor
154 camera
155 eye tracker
16 communication unit
17 bus
20 information processing apparatus
21 CPU
22 RAM
23 storage unit
231 program
24 operation display
25 communication unit
26 bus
30 virtual image
30A first display image
30B second display image
31 function bar
32 window shape change button
33 close button
40 space
40A first space
40B second space
41 visible area
51 virtual line
52 pointer
61 list screen
62 indicator
63 check box
64 delete button
65 scrolling screen
66 scroll bar
67 path
68 line
U user

1. A wearable terminal device configured to be used by being worn by a user, the wearable terminal device comprising:
at least one processor,
wherein the at least one processor
detects a visible area for the user inside a space,
causes a display to display, out of virtual images located in the space, a first virtual image that is located inside the visible area, and
when a second virtual image located outside the visible area is present, causes the display to perform display indicating in a prescribed manner existence of the second virtual image.

2. The wearable terminal device according to claim 1,
wherein the display includes a display member that is transparent to light, and
the at least one processor displays the first virtual image on a display surface of the display member with the first virtual image visible in the space that is visible through the display member.

3. The wearable terminal device according to claim 1, further comprising:
a camera configured to capture an image of the space,
wherein the at least one processor causes the display to display an image of the space captured by the camera and the first virtual image superimposed on the image of the space.

4. The wearable terminal device according to claim 1,
wherein when the second virtual image located outside the visible area is present, the at least one processor causes the display to display a list screen containing a list including the second virtual image.

5. The wearable terminal device according to claim 1,
wherein when the second virtual image located outside the visible area is present, the at least one processor causes the display to display a list screen containing a list including the first virtual image and the second virtual image.

6. The wearable terminal device according to claim 4,
wherein a display position of the list screen on the display is fixed regardless of a position and an orientation of the user in the space.

7. The wearable terminal device according to claim 4,
wherein in response to a prescribed operation performed on one virtual image included in the list screen, the at least one processor changes a display mode of the one virtual image.

8. The wearable terminal device according to claim 4,
wherein in response to a prescribed operation performed on the second virtual image, which is one of second virtual images included in the list screen, the at least one processor causes the display to perform display indicating a direction in which that second virtual image is located.

9. The wearable terminal device according to claim 4,
wherein in response to a prescribed copying operation performed on one virtual image contained in the list screen, the at least one processor copies the one virtual image and causes the display to display the copied one virtual image.

10. The wearable terminal device according to claim 9,
wherein the copying operation includes a dragging operation and a dropping operation performed on one virtual image included in the list screen, and
the at least one processor copies the one virtual image and causes the display to display the copied one virtual image at a position where the dropping operation is performed.

11. The wearable terminal device according to claim 9,
wherein when the at least one processor accepts an editing operation for the copied one virtual image, the at least one processor reflects edited content resulting from the operation in the one virtual image that is an origin of copying.

12. The wearable terminal device according to claim 4,
wherein the at least one processor, in response to a prescribed moving operation performed on one virtual image included in the list screen, moves the one virtual image to a position in accordance with the moving operation.

13. The wearable terminal device according to claim 12,
wherein the moving operation includes a dragging operation and a dropping operation performed on one virtual image included in the list screen, and
the at least one processor moves the one virtual image on which the dropping operation is performed.

14. The wearable terminal device according to claim 4,
wherein, in response to a deletion operation including an operation of selecting one or two or more virtual images included in the list screen, the at least one processor deletes, from the space, a selected virtual image or a not selected virtual image among virtual images included in the list screen.

15. The wearable terminal device according to claim 1,
wherein the at least one processor causes the display to display the second virtual image based on a first operation.

16. The wearable terminal device according to claim 15,
wherein the at least one processor displays the second virtual image at a position within a prescribed operation target range from a position of the user in the visible area.

17. The wearable terminal device according to claim 15,
wherein the at least one processor changes a size of the second virtual image and causes the display to display the second virtual image.

18. The wearable terminal device according to claim 15,
wherein the at least one processor aligns the first virtual image and the second virtual image in a prescribed manner.

19. The wearable terminal device according to claim 15,
wherein the virtual images each have a first surface and a second surface, and
the at least one processor causes the display to display each of the first virtual image and the second virtual image with one out of the first surface and the second surface facing the user.

20. The wearable terminal device according to claim 15,
wherein the at least one processor displays the first virtual image on the display in a mode according to a first rule, and displays the second virtual image on the display in a mode according to a second rule that is different from the first rule.

21. The wearable terminal device according to claim 15,
wherein the virtual images each have a first surface and a second surface, and
after displaying the second virtual image on the display, the at least one processor changes a surface of at least one of the virtual images that is displayed in accordance with a prescribed operation.

22. The wearable terminal device according to claim 15,
wherein the at least one processor aligns the first virtual image and the second virtual image in an order based on a prescribed condition.

23. The wearable terminal device according to claim 15,
wherein when displaying a plurality of the second virtual images on the display, the at least one processor displays a scrolling screen on the display that can display any part of the plurality of second virtual images in response to a scrolling operation.

24. The wearable terminal device according to claim 15,
wherein the at least one processor causes the display to display the second virtual image with the second virtual image overlapping at least a portion of the first virtual image.

25. The wearable terminal device according to claim 15,
wherein the at least one processor causes the display to perform display in a prescribed highlighted manner with one out of the first virtual image and the second virtual image standing out more prominently than another one out of the first virtual image and the second virtual image.

26. The wearable terminal device according to claim 15,
wherein when a second operation is performed after the second virtual images have been displayed on the display based on the first operation, the at least one processor returns at least one of the second virtual images to its original position.

27. The wearable terminal device according to claim 26,
wherein the at least one processor moves the second virtual image to its original position along a path that passes in front of the user.

28. The wearable terminal device according to claim 27,
wherein the at least one processor causes the display to display a line linking the second virtual image that has been returned to its original position to a prescribed position in the visible area.

29. The wearable terminal device according to claim 28,
wherein the at least one processor causes the display to display the second virtual image to which the line is linked in response to a prescribed operation performed on the line.

30. The wearable terminal device according to claim 1,
wherein the at least one processor generates the virtual images located in one out of a first space and a second space, which is separate from the first space, and
when the wearable terminal device is located in the first space, the at least one processor causes the display to perform display indicating existence of the second virtual image located in the second space.

31. The wearable terminal device according to claim 30,
wherein the at least one processor causes the display to perform display indicating existence of the second virtual image located in the second space when the wearable terminal device is moved from the second space to the first space.

32. A non-transitory computer-readable storage medium storing a program configured to cause a computer provided in a wearable terminal device configured to be used by being worn by a user to execute:
detecting a visible area for the user inside a space;
causing a display to display, out of virtual images located in the space, a first virtual image that is located inside the visible area, and
when a second virtual image located outside the visible area is present, causing the display to perform display indicating in a prescribed manner existence of the second virtual image.

33. A display method for use in a wearable terminal device configured to be used by being worn by a user, the method comprising:
detecting a visible area for the user inside a space;
causing a display to display, out of virtual images located in the space, a first virtual image that is located inside the visible area, and
when a second virtual image located outside the visible area is present, causing the display to perform display indicating in a prescribed manner existence of the second virtual image.
